(19) United States
(12) Patent Application Publication
(10) Pub. No.: US 2003/0145108 A1
(43) Pub. Date: Jul. 31, 2003

(54) System and method for network using redundancy scheme

(75) Inventors: Boby Joseph, Mt. Prospect, IL (US); Sanil Kumar Puthiyandiyil, Schaumburg, IL (US); Satish Amara, Mt. Prospect, IL (US); Rajesh Ramankutty, Schaumburg, IL (US); Shaji Radhakrishnan, Mt. Prospect, IL (US)

Correspondence Address: MCDONNELL BOEHNEN HULBERT & BERGHOFF, 300 SOUTH WACKER DRIVE, SUITE 3200, CHICAGO, IL, 60606, US

(73) Assignee: 3Com Corporation, Santa Clara, CA

(21) Appl. No.: 10/062,603

(22) Filed: Jan. 31, 2002

(51) Int. Cl. G06F 15/173

(52) U.S. Cl. 709/239

(57) ABSTRACT

A system and method is provided for transferring packet-switched data across a network. A network interface may be connected to a primary switch and a secondary switch, both of which may be connected to a network. The network interface may also convert between circuit-switched data and packet-switched data. Further, packet-switched data may be transferred between the network interface and the network across the primary switch if the primary switch is operable, and across the secondary switch if the primary switch is inoperable. The system and method may also include a selection switch, route server and controller. Additionally, the system and method may include a primary router and a secondary router. Packet-switched data may be transferred across the primary router if the primary router is operable, and across the secondary router if the primary router is inoperable.

### FIELD OF INVENTION

This invention relates to network communications. More specifically, it relates to a system and method for Voice Over Internet Protocol (VoIP) communications using a redundancy scheme.

### BACKGROUND OF THE INVENTION

Voice Over Internet Protocol (VoIP) is a method of communication that is becoming increasingly important. People from around the world may now utilize VoIP to communicate across Internet protocol (IP) networks in an inexpensive and efficient manner. A VoIP session may be initiated when a user makes a local telephone call across a Public Switched Telephone Network (PSTN) to an Internet Service Provider (ISP). Circuit-switched data, such as voice data recorded from an audio-recording device, may be converted into IP packets and transferred to a receiving machine over an IP network. For more information on VoIP, one can refer to commonly owned U.S. Pat. No. 6,259,691. U.S. Pat. No. 6,259,691 is hereby specifically incorporated in its entirety herein by reference.

As the importance of IP networks such as the Internet continues to grow, it is evident that VoIP will continue to be an important method of communication. However, current methods of VoIP have various shortcomings. Often, the desire for high-bandwidth service and minimal packet loss pose special challenges for VoIP systems. Components in VoIP systems, such as switches, routers, and connections between switches and routers, will fail over time due to conditions such as software failure, mechanical wear, power loss, or external damage. In prior art VoIP systems, such failures often result in significant packet losses. These packet losses in turn often cause audible breaks that interrupt conversations or create disruptions in fax transmissions. In some cases, communication on the system breaks completely, forcing users to reconnect before conversation or transmission can resume.

Accordingly, it is desirable to have a VoIP system that overcomes the above deficiencies associated with the prior art by utilizing a redundancy scheme to prevent switch, router, and connection failures from resulting in lowered network reliability and communication quality.

### SUMMARY

The present application provides a network system comprising a network interface for a first network connected to a primary switch and a secondary switch. Further, the primary switch and the secondary switch may be connected to a second network. Packet-switched data may be transferred between the network interface and the second network across the primary switch if the primary switch is operable. Additionally, packet-switched data may be transferred between the network interface and the second network across the secondary switch if the primary switch is inoperable. The network system may also be comprised of a selection switch, a route server, and a controller.

In addition, the present application provides a method for transferring packet-switched data. The method of the present invention comprises the steps of determining if a primary switch and a first link are operable, transferring packet-switched data across the primary switch if the primary switch and the first link are operable, and transferring the packet-switched data across a secondary switch if at least one of the primary switch and the first link are inoperable. The method may further include converting between circuit-switched data and the packet-switched data. Additionally, the method may comprise determining if a primary router is operable, and transferring the packet-switched data between the network interface and a secondary router if the primary router is inoperable.

Furthermore, the present application provides a network assembly comprising a digital signal processing (DSP) card connected to a primary switch and a secondary switch. The DSP card may convert between voice data and IP packets. The network assembly may also comprise a selection switch that is connected to the DSP card, the primary switch and the secondary switch. If the primary switch is operable, the selection switch may enable the IP packets to be transferred across the primary switch. Alternatively, if the primary switch is inoperable, the selection switch may enable the IP packets to be transferred across the secondary switch. The network assembly may further comprise a route server connected to the selection switch, and a controller connected to the primary switch. The route server may control the functioning of the selection switch, and the controller may monitor and deactivate the primary switch if the primary switch is inoperable.

### BRIEF DESCRIPTION OF THE DRAWINGS

FIG. 1 is a block diagram illustrating an exemplary network system.

FIG. 2 is a block diagram illustrating an exemplary switching assembly and control system for use in the network system of FIG. 1.

FIG. 3 is a block diagram illustrating an exemplary network device and egress network for use in the network system of FIG. 1.

FIG. 4 is a block diagram illustrating another exemplary network device and egress network for use in the network system of FIG. 1.

FIG. 5a is a block diagram illustrating network addressing and communications within the network system of FIG. 1 using the network device and egress network of FIG. 3.

FIG. 5b is a block diagram illustrating an exemplary packet format for use in the network system of FIG. 1.

FIG. 5c is a block diagram illustrating an exemplary addressing table for use in the network system of FIG. 1.

FIG. 6a is a flow diagram illustrating an exemplary operation of the network system of FIG. 1, wherein the network system is operable and data is sent from an ingress network to an egress network.

FIG. 6b is a flow diagram illustrating another exemplary operation of the network system of FIG. 1, wherein the network system is operable and data is sent from an egress network to an ingress network.

FIG. 7 is a flow diagram illustrating an exemplary operation of the network system of FIG. 1 with the network device and egress network of FIG. 3, wherein a primary switch for use in the network system is inoperable.

FIG. 8 is a flow diagram illustrating an exemplary operation of the network system of FIG. 1 with the network device and egress network of FIG. 3, wherein a first link for use in the network system is inoperable.

FIG. 9 is a flow diagram illustrating an exemplary operation of the network system of FIG. 1 with the network device and egress network of FIG. 3, wherein a port in a primary router for use in the network system is inoperable.

FIG. 10 is a flow diagram illustrating an exemplary operation of the network system of FIG. 1 with the network device and egress network of FIG. 4, wherein a primary router for use in the network system is inoperable.

### DETAILED DESCRIPTION

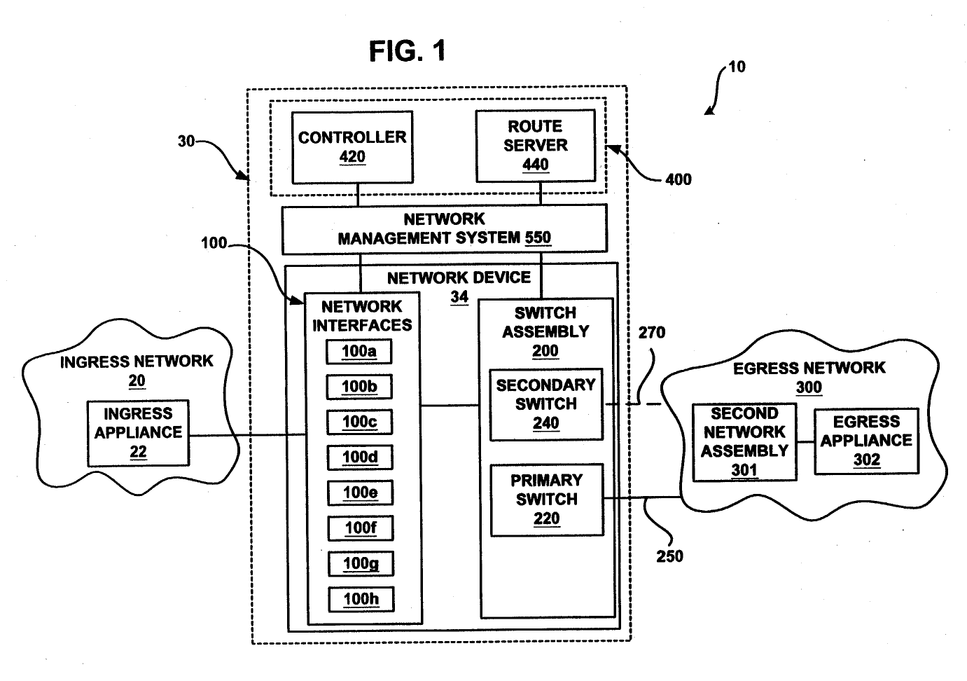

FIG. 1 shows a block diagram overview illustrating an exemplary embodiment of a network system 10. The network system 10 comprises a first network, such as an ingress network 20, utilizing a network assembly 30 to communicate with a second network, such as an egress network 300. The ingress network 20 may comprise an ingress appliance 22, and the egress network 300 may comprise a second network assembly 301 in communication with an egress appliance 302. In an exemplary embodiment, the network assembly 30 and the second network assembly 301 are the same and stored at different central offices (COs). Also, although not shown, it should be understood that the networks 20, 300 may comprise any number of different network appliances, such as personal computers, smart phones, cellular phones, and fax machines. Further, the appliances 22, 302 may utilize a Public Switched Telephone Network (PSTN) (not shown) to connect with one another. In this exemplary embodiment, the network system 10 may be a Voice-Over Internet Protocol (VoIP) system that enables the ingress appliance 22 to communicate audibly with the egress appliance 302 using packet-switched data. It should be also understood that communication between the two appliances 22, 302 is preferably full-duplex, though half-duplex communication may also be utilized.

As shown in FIG. 1, the network assembly 30 may include a network device 34. The network device 34 preferably comprises a plurality of network interfaces 100 that are in communication with the egress network 300 via a switch assembly 200. Each of the network interfaces 100 may also be connected to and in communication with a network management system 550, which in turn may control the network interfaces 100 and maintain their state information. Additionally, the network assembly 30 may include a control system 400 that is coupled to and in communication with the network interfaces 100 and the switch assembly 200 via the network management system 550. The control system 400 may have a controller 420 that controls system power and monitors the functioning of the switch assembly 200. The control system 400 may further include a route server 440 that controls data flow through the switch assembly 200. It should be understood that the control system 400 may be connected directly to the network interfaces 100 and/or the switch assembly 200 without involving the network management system 550. Additionally, in alternate embodiments of the present invention, the network assembly 30 may comprise more than one network device 34.

In the present embodiment, each of the plurality of network interfaces 100 may be a digital signal processing (DSP) card that utilizes the VoIP protocol and converts between circuit-switched data and packet-switched data. Preferably, the circuit-switched data comprises fax data or voice data recorded from an audio-recording device such as a microphone, and the packet-switched data comprises IP packets. As shown in FIG. 1, the network device 34 preferably comprises eight such network interfaces 100, which are numbered 100a through 100h. Data received from the ingress network 20 may be split between the network interfaces 100 by methods such as time-division multiplexing or frequency-division multiplexing. It should be understood that while eight network interfaces 100 are shown in FIG. 1, any number of network interfaces may be used in alternate embodiments of the present invention, and that some network interfaces may be active and others inactive or standby.

The switch assembly 200 may include any number of different types of switches or switch fabrics, depending upon network preferences. In this exemplary embodiment, the switch assembly 200 comprises a primary switch 220 and a secondary switch 240. The switches 220, 240 are preferably the same, except the primary switch 220 may be an active switch and the secondary switch 240 may be a standby switch. In other words, packet-switched data preferably passes through the primary switch 220 when the primary switch 220 is operable, and through the secondary switch 240 when the primary switch 220 is inoperable. It should be understood that in alternate embodiments, data may be passed through both switches 220, 240 simultaneously.

As illustrated in FIG. 1, a first link 250 and second link 270 preferably connect the egress network 300 to the primary switch 220 and secondary switch 240, respectively. Preferably, the first link 250 and the second link 270 are comprised of optical fiber and utilize fiber optic communications. Thus, a laser may be utilized for transmitting packet-switched data along the links 250, 270. Additionally, the controller 420 and/or route server 440 may control power to the links 250, 270 and switches 220, 240. Thus, the controller 420 and/or route server 440 may activate or deactivate each link 250, 270 and/or switch 220, 240 depending on their operability. For instance, during normal operation, the first link 250 may be an active connection between the primary switch 220 and the egress network 300. However, if the first link 250 or primary switch 220 fails, the second link 270 and secondary switch 240 may become activated. Thus, the network system 10 preferably utilizes a redundancy scheme that enables the network system 10 to function properly even when the primary switch 220 or the first link 250 fail. It should be understood that although only two links 250, 270 are shown in FIG. 1, more or fewer links may be utilized in alternate embodiments of the present invention.

Additionally, controller 420 and/or the route server 440 may explicitly deactivate the primary switch 220 and/or first link 150 by purposely shutting down the laser used for fiber optic communications. This may be especially useful if maintenance operations (e.g., hardware changes, software upgrades, etc.) are to be performed on the primary switch 220 and/or first link 250, since shutting down the laser for the first link 250 will preferably cause the network system 10 to automatically start using the secondary switch 240 and second link 270.

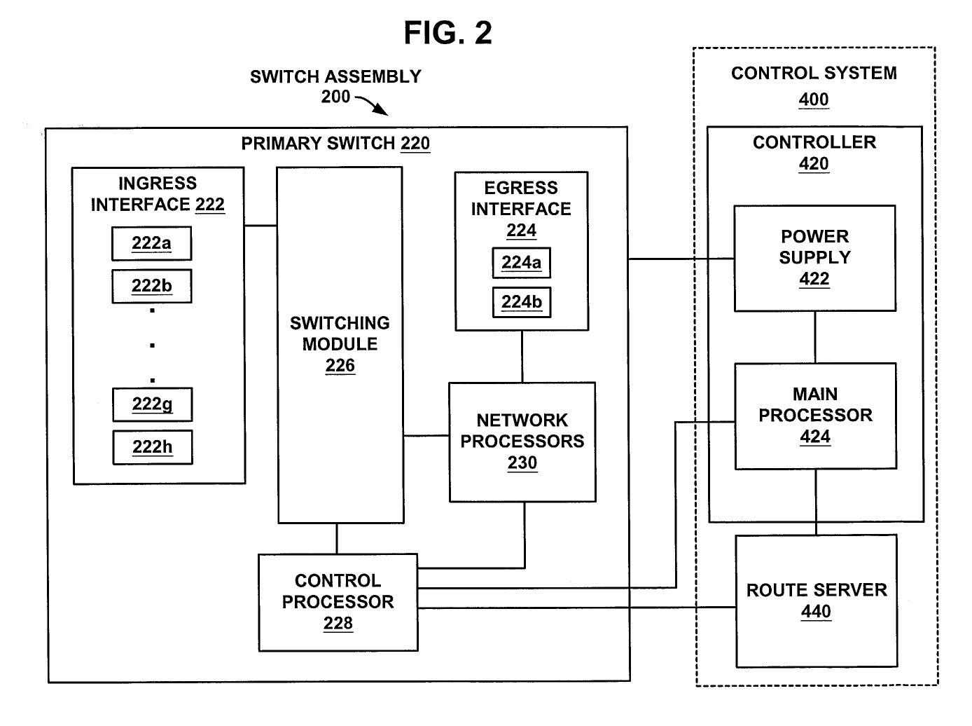

Turning now to FIG. 2, the switching assembly 200 and control system 400 are shown in more detail. The primary switch 220 may include an ingress interface 222 that communicates data with the network interfaces 100. The primary switch 220 may also include an egress interface 224 that communicates data with the egress network 300. Preferably, the data transmitted across interfaces 222, 224 includes packet-switched data, such as IP packets. Both interfaces 222, 224 may be comprised of a number of sub-interfaces, each one independent and able to communicate with a different device or port. FIG. 2 shows that the exemplary ingress interface 222 comprises eight sub-interfaces, labeled 222a-222h, and the egress interface 224 comprises two sub-interfaces 224a, 224b. The number of sub-interfaces may reflect the number of devices or ports to which the interfaces 222, 224 are connected. For example, if the network device 34 includes ten network interfaces 100, the ingress interface 222 may have ten sub-interfaces. Similarly, if there are four links between the primary switch 220 and the egress network 300, the egress interface 224 may have four sub-interfaces. It should be understood that the number of sub-interfaces on either interface 222, 224 may be more or less than described here depending on consumer and/or manufacturing preferences.

The primary switch 220 may also include a switching module 226. The switching module 226 may be a layer 2 (i.e., data link layer) switch under the Open Systems Interconnection (OSI) standard. Layer 2 of the OSI standard is often associated with Media Access Control (MAC) addressing. Alternatively, the switching module 226 may be both a layer 2 and layer 3 (i.e., network layer) switch. The switching module 226 may enable data to travel between any of the sub-interfaces within the ingress interface 222 and the egress interface 224. For example, the switching module 226 may transfer data received from the egress interface 224 to any of the sub-interfaces 222a-222h of the ingress interface 222. Conversely, the switching module 226 may transfer data received from the ingress interface 222 to either of the sub-interfaces 224a, 224b of the egress interface 224.

The primary switch 220 may also include a control processor 228 connected to one or more network processors 230. The control processor 228 may initially configure the network processors 230 and arrange filtering rules and other initial considerations. The control processor 228 may also connect to the switching module 226. Additionally, the control processor 228 may communicate with the controller 420 and the route server 440 as a client module. Furthermore, the route server 440 may use the control processor 228 to control the functioning of the network processors 230 and/or the switching module 226.

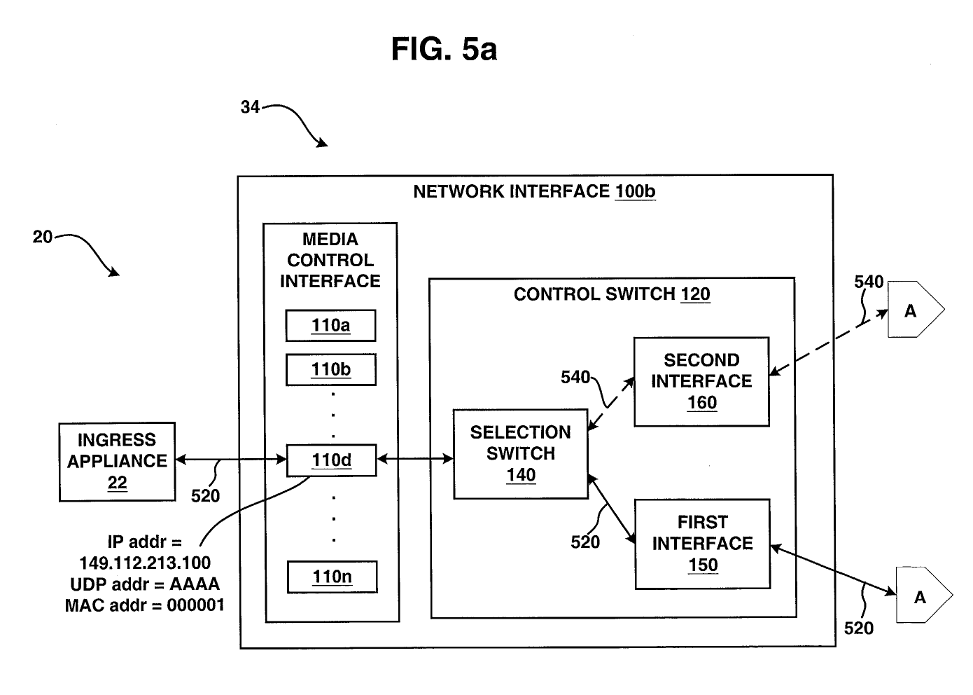

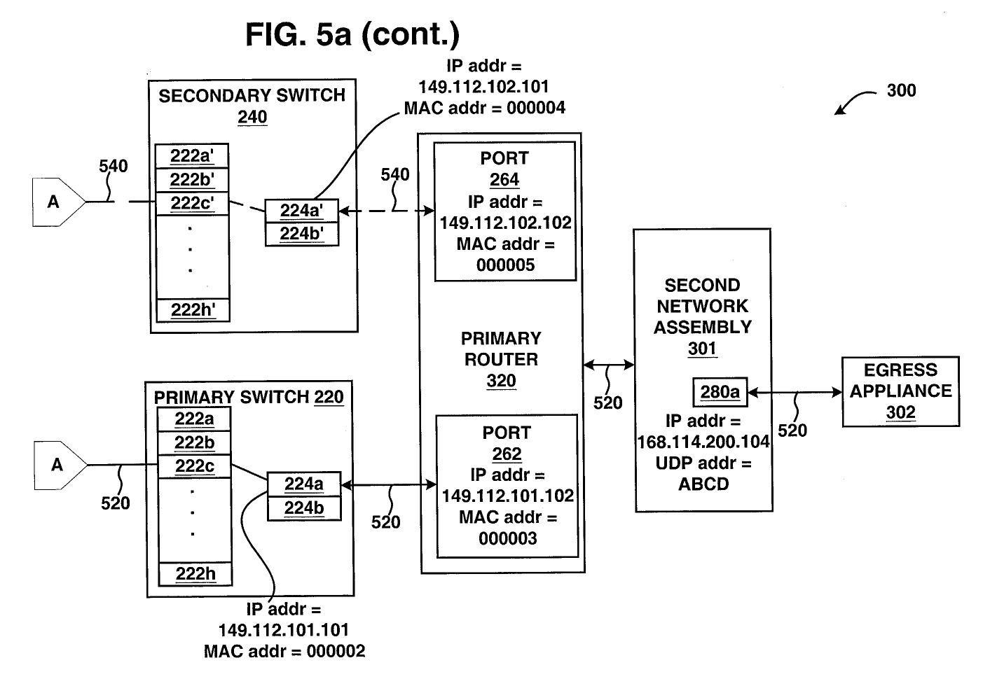

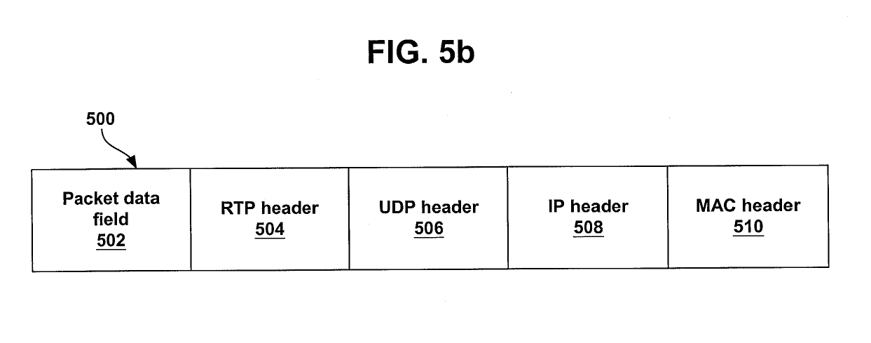

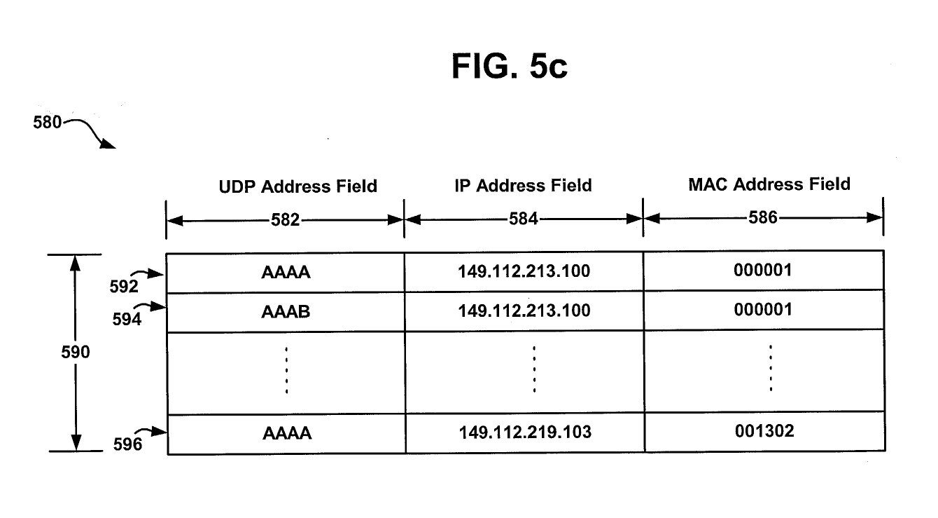

In addition, the network processors 230 may connect with the ingress interface 222 through the switching module 226, and directly connect with the egress interface 224. Alternatively, the network processors 230 may connect with the egress interface 224 through the switching module 226, and directly connect with the ingress interface 222. Under the guidance of the control processor 228, the network processors 230 may process data passed between the interfaces 222, 224. The network processors 230 may also analyze data passed from the switching module 226. Furthermore, the network processors 230 may rewrite packet headers or other information associated with the data as well as read and store packet header information in an addressing table. As described below (see FIG. 5c), the addressing table may contain packet addressing information (e.g., IP, User Datagram Protocol (UDP), and MAC addresses) that may be stored in a memory (not shown) within the primary switch 220, secondary switch 240, and/or route server 440.

Additionally, the network processors 230 may also enable the data to move between an incoming sub-interface and an outgoing sub-interface by controlling the function of the switching module 236. Preferably, the network processors 230 work together as parallel processors when the primary switch 220 is operable. In this exemplary embodiment, there may be eight network processors 230, but it should be understood that more or fewer processors may be utilized. It should be further understood that all processors 228, 230 discussed thus far may be comprised of one or more integrated circuits.

Although only the structure of the primary switch 220 has been described thus far, it should be understood that the structure of the secondary switch 240 is preferably the same. Therefore, the secondary switch 240 may also have an ingress interface, egress interface, switching module, control processor, memory, and network processors (not shown) that are preferably the same as their primary switch counterparts described above. It should be understood that any reference hereinafter to the components within the primary switch 220 may also be applicable to components within the secondary switch 240.

Turning now to the control system 400, the controller 420 preferably includes a power supply 422 and a main processor 424. A variety of devices may be used for the power supply 422, such as a smart-power generator, power pack, or AC adaptor. Additionally, the main processor 424 may utilize an integrated circuit and include communication mechanisms with other components, such as Ethernet and serial bus modules. The power supply 422 preferably provides power to all components within the network device 30, including the primary switch 220 and secondary switch 240. The main processor 424 may power up or shut down any component within the network device 34 by controlling the function of the power supply 422. Furthermore, the main processor 424 may be in communication with the route server 440, and the control processor 228 in the primary switch 220. It should be understood that alternate embodiments of the present invention may utilize redundant or standby controllers in case the controller 420 fails.

Preferably, the control processor 228 within the primary switch 220 maintains communication with the main processor 424 of the controller 420 through a heartbeat mechanism. Thus, the control processor 228 may indicate that the primary switch 220 is healthy by sending out a periodic pulse to the main processor 424. If the control processor 228 fails to send pulses to the main processor 424 within a threshold time period, the controller 420 may infer that the primary switch 220 is not working and cut power to the broken switch. Alternatively, the switch assembly 200 may notify the controller 420 that the first link 250 is inoperable, and the controller 420 may then cut power to the primary switch 220 and/or the first link 250 (e.g., shut off the laser). The controller 420 may also allow the primary switch 220 to deactivate the first link 250 itself. It should be understood that the procedures described here may also be applied to the secondary switch 240 and/or the second link 270.

The route server 440 may include any number of different network interfaces, such as a router, media gateway controller, redundancy handler, computer workstation, or server. The route server 440 preferably serves as a processing unit that controls where data flows within the switch assembly 200. Thus, the route server 440 may include a server module that is in communication with the control processor 228 within the primary switch 220. Furthermore, the route server 440 may have a client module that is in communication with the main processor 424 in the controller 420. Additionally, the route server 440 may reconfigure data flow within the switch assembly 200 whenever a switch within the switch assembly 200 fails. It should be understood that a variety of configuration parameters (e.g., IP addresses, MAC addresses) may be passed between the route server 440 and other components of the network device 30. It should be further noted that redundant or standby route servers may be utilized in alternate embodiments of the present invention if the route server 440 fails.

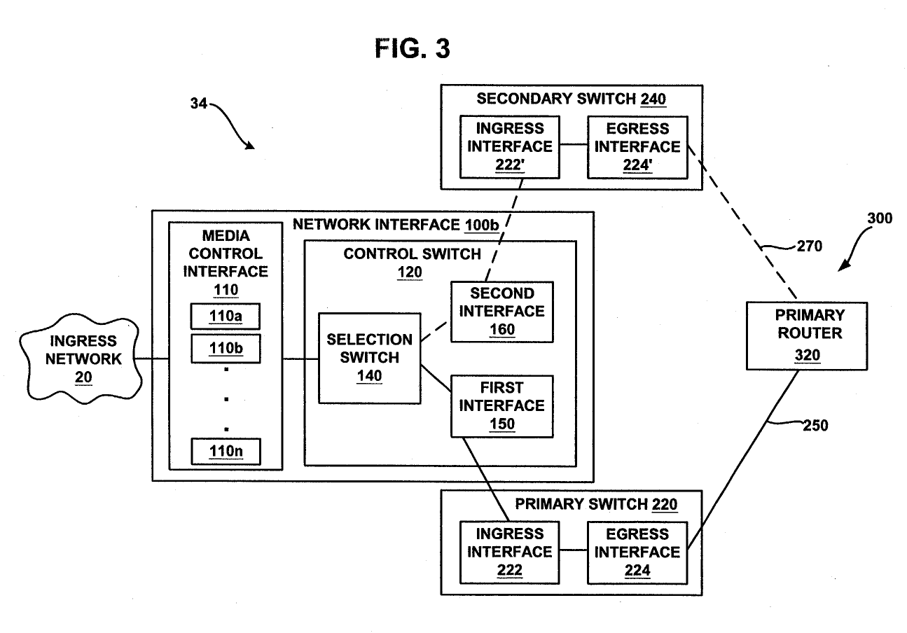

Turning now to FIG. 3, the exemplary network device 34 is shown in more detail. Additionally, a single network interface 100b from the plurality of network interfaces 100 is shown. It should be understood that all members of the set of network interfaces 100 (e.g., 100a-h) are preferably the same, and that only one network interface 100b is shown in FIG. 3 for ease of reference.

The network interface 100b preferably comprises fourteen media control interfaces 110, which are numbered 110a through 110n. It should be understood that while fourteen media control interfaces 110 are shown in FIG. 3, any number of media control interfaces may be used with the network interface 100b of the present invention, and that some media control interfaces may be active and others inactive or standby. The media control interfaces 110 may be utilized to process VoIP calls received from the ingress network 20 and the egress network 300. In an exemplary embodiment, each media control interface 110 is capable of handling up to eighty-four (84) VoIP calls and may convert between circuit-switched and packet-switched data. In addition, each of the media control interfaces 110 may add, alter or remove packet headers from data passing through the network device 34. Packet headers may facilitate full-duplex communication between the networks 20, 300, and as such will be described in more detail shortly.

The network interface 100b also may comprise a control switch 120. A selection switch 140 located on the control switch 120 may be connected to each of the media control interfaces 110. Additionally, the selection switch 140 may be connected to and controlled by the route server 440 (connection not shown). The control switch 120 also may comprise a first interface 150 and a second interface 160, both of which are connected to the selection switch 140. The first interface 150 and the second interface 160 are preferably the same and may be Gigabit Ethernet interfaces, which are well known in the art. Additionally, the first interface 150 may be connected to the ingress interface 222 on the primary switch 220, and the second interface 160 may be connected to an ingress interface 222′ on the secondary switch 240. As described earlier, the secondary switch 240 may also include an egress interface 224′, and interfaces 222′, 224′ on the secondary switch 240 are preferably the same as interfaces 222, 224, respectively, on the primary switch 220.

The selection switch 140 may be any intelligent or non-intelligent switch that is layer 2 aware within the OSI standard. Alternatively, the selection switch 140 may be both layer 2 and layer 3 aware. If the primary switch 220 and the first link 250 are operable, the selection switch 140 may enable packet-switched data to travel across the first interface 150. Thus, the packet-switched data may travel across the primary switch 220 and the first link 250. On the other hand, if the primary switch 220 or the first link 250 is inoperable, the selection switch 140 may direct packet-switched data to travel across the second interface 160. In these cases, the packet-switched data may travel across the secondary switch 240 and the second link 270. The route server 440 preferably determines the functioning of the selection switch 140. Thus, the route server 440 preferably determines whether packet-switched data travels across the primary switch 220 or the secondary switch 240.

As shown in FIG. 3, the egress network 300 includes a primary router 320. Routers, such as the router 320, are well known in the art. The primary router 320 may have ports (not shown) connected to the first link 250 and the second link 270. The primary router 320 may also be connected to the other parts of the egress network 300 (e.g., the second network assembly 301) via other ports. Therefore, data may be transferred between network appliances on the egress network 300 and the network device 34 across the primary router 320.

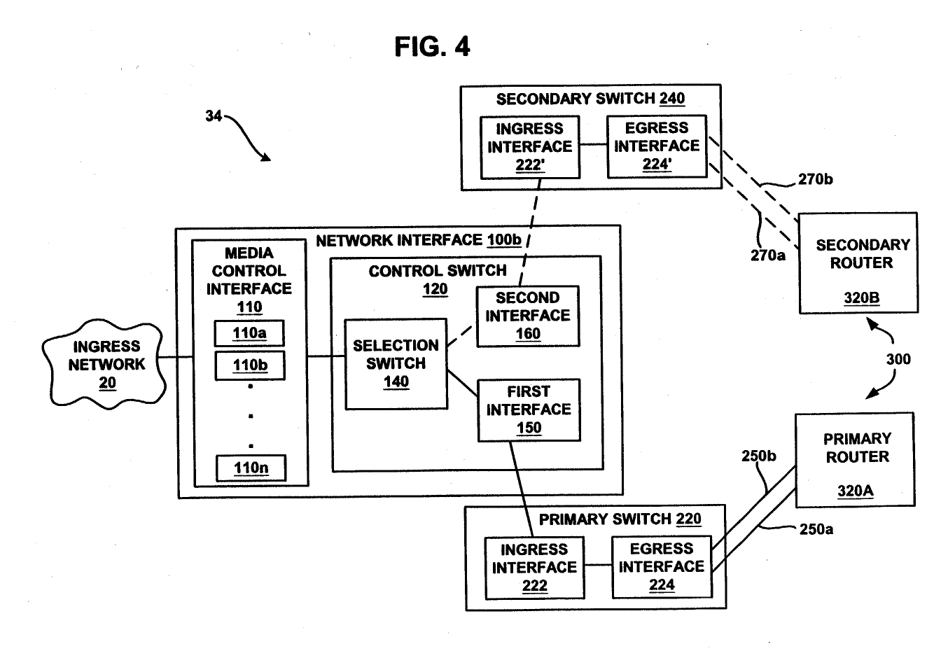

Turning now to FIG. 4, another exemplary embodiment of a network device 34 and egress network 300 is shown. The exemplary embodiment shown in FIG. 4 is preferably the same as discussed in FIG. 3, except that the egress network 300 now contains both a primary router 320a and a secondary router 320b. The routers 320a, 320b are both preferably the same as router 320. The primary switch 220 is connected to the primary router 320a by a first link 250a and a first standby link 250b. Similarly, the secondary switch 240 is connected to the secondary router 320b by a second link 270a and a second standby link 270b. The links 250a, 250b, 270a, and 270b are preferably the same as links 250, 270 described earlier.

Turning now to FIG. 5a, an exemplary network addressing scheme within the network system 10 is shown in more detail. This exemplary network addressing scheme utilizes the network device 34 and egress network 300 as shown in FIG. 3. However, it should be understood that alternate network addressing schemes may use different embodiments of the network device and egress network, such as described in FIG. 4. In an exemplary embodiment, the ingress appliance 22 calls into the network interface 100b and is received by the media control interface 110d. An exemplary source IP address of “149.112.213.100” and source MAC address of “000001” (hex) is mapped from the media control interface 110d to the ingress appliance 22. Additionally, a UDP address (e.g., “AAAA” hexadecimal) may be chosen from a range of possible UDP addresses and mapped to the ingress appliance 22.

Furthermore, through a standard VoIP protocol such as the Session Initiation Protocol (SIP) or Media Gateway Control (MEGACO), an exemplary destination IP address (e.g., “168.114.200.104”) and UDP address (e.g., “ABCD”) may also be determined. These destination addresses may correspond to the addresses of a second media control interface 280a located on the second network assembly 301. Preferably, the second media control interface 280a is similar to the media control interface 110d. Also, the connection between the second media control interface 280a and the egress appliance 302 is preferably similar to the connection between the media control interface 110d and the ingress appliance 22. In the present embodiment, source and destination IP and UDP addresses for a call originating from the ingress appliance 22 may be stored in packets created by the media control interface 110d. It should be understood that although only media control interfaces 110d, 280a are being discussed in this exemplary embodiment, any number of other media control interfaces may be utilized with the present invention.

Also as shown in FIG. 5a, data may be transferred between the two appliances 22, 302 via an active connection 520 (indicated by a solid line) and/or a standby connection 540 (indicated by a dotted line). For example, data traveling from the ingress appliance 22 to the egress appliance 302 may travel along the active connection 520 though the media control interface 110d located on the network interface 100b. After exiting the media control interface 100d, the data may travel along the active connection 520 through the selection switch 140. After this point, the data may continue to travel along active connection 520, or it may switch to the standby connection 540. Data traveling along the active connection 520 may continue through the first interface 150 and on to the ingress sub-interface 222c located on the primary switch 220. The data traveling along the active connection 520 may then proceed to pass through the egress sub-interface 224a, which has an exemplary IP address of “149.112.101.101” and an exemplary MAC address of “000002”. The data may be then received by an active port 262 on the primary router 320 having an exemplary IP address of “149.112.101.102” and an exemplary MAC address of “000003”. Additionally, the primary router 320 may be further connected to the egress appliance 302 via the second network assembly 301 and the second media control interface 280a, thereby completing the active connection 520 between the appliances 22, 302.

Conversely, data traveling along the standby connection 540 may pass through the second interface 160 within the control switch 120 and on to ingress sub-interface 222c′ located on the secondary switch 240. The data moving along the standby connection 540 may then continue through the egress sub-interface 224a′, which has an exemplary IP address of “149.112.102.101” and an exemplary MAC address of “000004”. It should be understood that alternatively, the data may travel through any of the ingress interfaces 222a′-222h′ and egress interfaces 224a′, 224b′ within the secondary switch 240. It should be further understood that a switching module, control processor, and network processors are preferably present within the primary switch 220 and secondary switch 240, but are not shown in FIG. 5a for clarity and ease of reference.

After passing through the secondary switch 240, the data traveling along the standby connection 540 may then be received by a standby port 264 on the primary router 320 having an exemplary IP address of “149.112.102.102” and an exemplary MAC address of “000005”. At this point, the standby connection 540 may rejoin the active connection 520, and data may travel along the active connection 520 between the primary router 320 and the egress appliance 302 via the second network assembly 301 and the second media control interface 280a.

Although data traveling along connections 520, 540 has been described as passing from the ingress appliance 22 to the egress appliance 302, it should be understood that both connections 520, 540 are preferably full duplex, and that data may travel between the appliances 22, 302 in either direction along either connection 520, 540. Furthermore, it should be understood that the recitation of exemplary IP, UDP and MAC addresses is intended to illustrate, not limit, the spirit and scope of the present invention. In addition, in this exemplary embodiment, an IP Version 4 (IPv4) addressing standard has been utilized. However, it should be noted that other addressing standards may also be utilized with the present invention, including the IPv4 subnet addressing standard and IP Version 6 (IPv6) standard. For more information regarding IP addressing, one can refer to Request for Comments (RFC) 791 (“Internet Protocol”) and RFC 2373 (“IP Version 6 Addressing Architecture”). RFC 791 and RFC 2373 are hereby specifically incorporated in their entirety herein by reference.

It should be noted that the IP address of the egress sub-interface 224a (“149.112.101.101”)and the IP address of the active port 262 (“149.112.101.102”) may have the same first three numbers. The IPv4 Class C standard defines a network-number as the first three numbers within an IP address. Thus, the egress sub-interface 224a and the active port 262 preferably have the same network-number (“149.112.101”) and thus share the same network. Similarly, the egress sub-interface 224a′ and the standby port 264 preferably have the same network-number (“149.112.102”) and share the same network. In this exemplary embodiment, either the ports 262, 264 on the primary router 320, or the egress sub-interfaces 224a, 224a′ on the primary switch 220, may be configured so that corresponding components share network-numbers. The determination of which ports 262, 264 and/or egress sub-interfaces 224a, 224a′ to configure may be made in accordance with consumer and/or manufacturing preferences.

Turning now to FIG. 5b, an exemplary packet format 500 is shown for use in the network system of FIG. 1. A number of packets utilizing the exemplary packet format 500 may comprise the packet-switched data that passes through the network system 10. The packet format 500 may include a number of different headers and fields, such as a packet data field 502, Real-Time Transport Protocol (RTP) header 504, UDP header 506, IP header 508, and MAC header 510. It should be understood that other headers, such as a Transmission Control Protocol (TCP) header and a Cyclic Redundancy Check (CRC) header, may be used in alternate embodiments of the present invention, and that more or fewer headers may be used depending on consumer and/or manufacturing preferences.

The packet data field 502 preferably contains digital data pertaining to a VoIP call between appliances 22, 302. The RTP header 504, UDP header 506, IP header 508, and MAC header 510 may each include source and destination addresses that may be written and/or rewritten during the transmission of a packet with packet format 500 between the appliances 22, 302. For example, the UDP header may contain both a UDP source address and a UDP destination address. It should be understood that portions of the headers 504, 506, 508, 510 may be added, altered, or removed during the transmission of a packet with format 500. For more information on RTP, UDP, and MAC headers, one can refer to RFC 1889, RFC 768, and IEEE 802.3 Ethernet Standard, respectively. RFC 1889, RFC 768, and the IEEE 802.3 Ethernet Standard are hereby specifically included in their entirety herein by reference.

FIG. 5c shows an exemplary addressing table 580 that may be stored within a memory inside the primary switch 220. Additionally, a copy of the table may be stored within the route server 440. The table 580 may have a plurality of entries 590, each entry having a UDP address within a UDP address field 582, an IP address within an IP address field 584, and a MAC address within a MAC address field 586. Each IP/MAC address pair within the table 580 may uniquely identify a media control interface 110. Additionally, a number of UDP addresses may be assigned by the route server 440 to each media control interface 110 and correspond to different ports on the device. In the present embodiment, the media control interface 110d may have 84 UDP addresses that correspond to the 84 ports that it utilizes for handling VoIP calls.

Preferably, the table 580 outputs a MAC address from the MAC address field 586 when an IP address and UDP address for a corresponding entry are given as inputs. For example, if an IP address of “149.112.213.100” and a UDP address of “AAAA” or “AAAB” are inputs to the table 580 (e.g., corresponding to entries 592, 594), the MAC address “000001” may be an output. Alternatively, if an IP address of “149.112.219.103” and a UDP address of “AAAA” are inputs to the table 580 (e.g., corresponding to entry 596), the MAC address “001302” may be an output.

Although only table 580 is shown, it should be understood that the secondary switch 240 may also contain a table that is preferably the same as table 580. It should be further understood that alternate embodiments of the table 580 may utilize more or fewer fields, such as additional UDP or IP address fields, depending on consumer and/or manufacturing preferences.

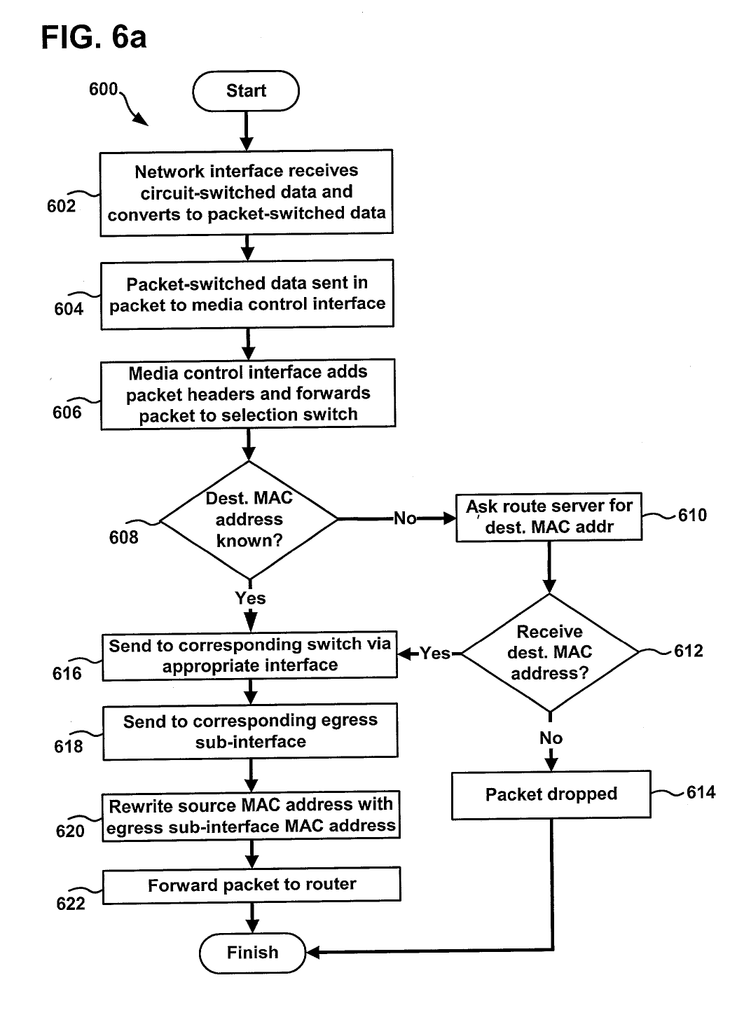

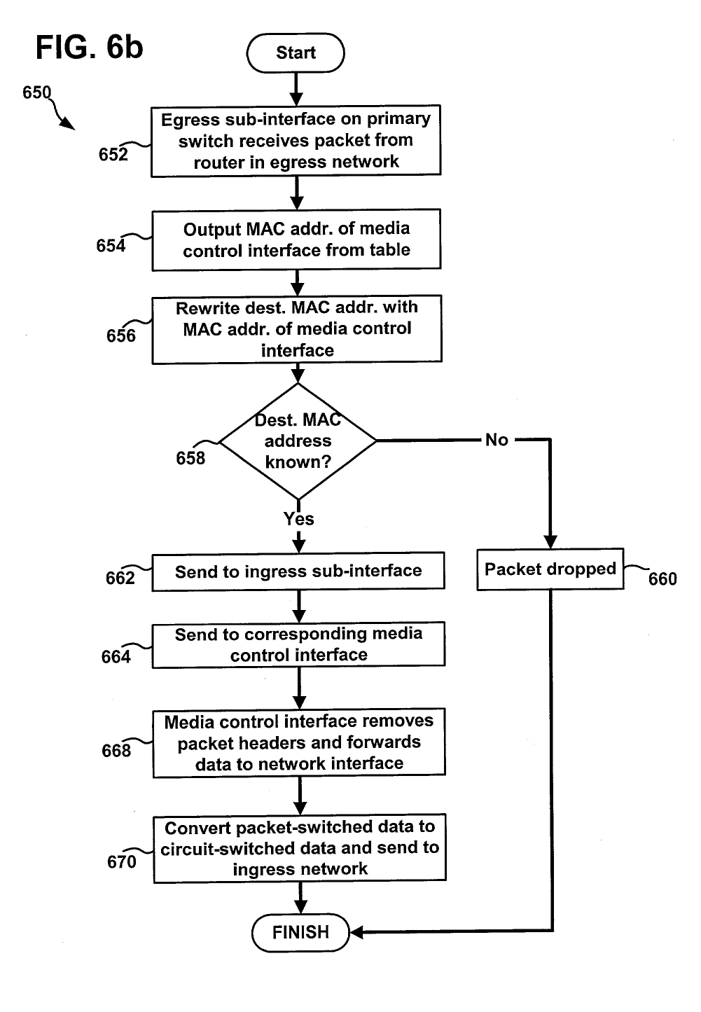

Turning now to FIG. 6a, an exemplary method of operation 600 of the network system 10 is shown. More specifically, FIG. 6a shows an exemplary method 600 when the network system is operable and data is sent from the ingress network 20 to the egress network 300. In step 602, the exemplary network interface 100b may receive circuit-switched data from the ingress appliance 22 and convert the circuit-switched data into packet-switched data. In step 604, the packet-switched data may be included in the packet data field 502 of a packet with format 500 and passed to the exemplary media control interface 110d.

In step 606, the media control interface 110d may add packet headers, such as the RTP header 504, UDP header 506, IP header 508, and MAC header 510, to the packet with format 500. Corresponding to the addresses shown in FIG. 5a, the source UDP address stored within the UDP header 506 may be the UDP address of the media control interface 110d that has been mapped to the ingress appliance 22 (“AAAA”). The destination UDP address stored within the UDP header 506 may be the UDP address of the second media control interface 280a that has been mapped to the egress appliance 302 (“ABCD”). Similarly, the source IP address within the IP header 508 may be the IP address of the media control interface 110d that has been mapped to the ingress appliance 22 (“149.112.213.100”), and the destination IP address may be the IP address of the second media control interface 280a that has been mapped to the egress appliance 302 (“168.114.200.104”). The destination UDP and IP addresses may be determined using a known protocol, such as SIP or MEGACO. Within the MAC header 510, the source MAC address may be the MAC address of the media control interface 110d (“000001”), and the destination MAC address may be the MAC address of the active port 262 of the primary router 320 (“000003”). Alternatively, if the primary switch 220, first link 250, or active port 262 is inoperable, the destination MAC address may be the MAC address of the standby port 264 (“000005”). The destination MAC address may be specified by the route server 440, which may control data flow within the network assembly 30.

Also in step 606, the packet with format 500 is forwarded to the selection switch 140. In step 608, a determination is made whether the destination MAC address within the MAC header 510 is known. If the destination MAC address is not known, the method 600 may move to step 610, where the selection switch 240 may request a destination MAC address from the route server 440. In the following step 612, a determination is made whether a destination MAC address has been received from the route server 440. If a destination MAC address has been received, the method 600 may move to step 616, which will be described shortly. If the destination MAC address has not been received, the method 600 may proceed to step 614 and the packet may be dropped. Alternatively, if no destination MAC address has been received, the packet with format 500 may be copied within the control switch 120, and broadcast to all of the ingress sub-interfaces 222a-h, 222a′-h′ and egress sub-interfaces 224a-b and 224a′-b′ within both switches 220, 240.

Returning to the determination in step 608, if the destination MAC address within the MAC header 510 is known, the method 600 moves to step 616, and the selection switch 140 forwards the packet to the first interface 150 or the second interface 160, depending on what the destination MAC address is. For example, if the destination MAC address is “000003”, the selection switch may forward the packet to the first interface 150 en route to the ingress sub-interface 222c on the primary switch 220. Similarly, if the destination MAC address is “000005”, the selection switch may forward the packet to the second interface 160 en route to the ingress sub-interface 222c′ on the secondary switch 240. It should be understood that any of the ingress sub-interfaces 222a-h or 222a′-h′ may be utilized in this present step. Further, it should be understood that the determination of whether the destination MAC address is known may also occur in other components of the network device 30, such as the switching module 226.

The method 600 may then move to step 618, where the packet with format 500 is sent to a corresponding egress sub-interface. In this exemplary embodiment, the packet may be forwarded to either egress sub-interface 224a, or 224a′, depending on whether the packet has been forwarded to the primary switch 220 or the secondary switch 240. It should be understood that any of the egress sub-interfaces 224a-b, 224a′-b′ may be utilized in the present step.

In step 620, the source MAC address within the MAC header 510 of the packet with format 500 may be rewritten by the corresponding egress sub-interface MAC address. For example, for an exemplary packet with format 500 passing through the primary switch 220, the source address within the MAC header 510 (“000001”) may be replaced by the MAC address of the egress sub-interface 224a (“000002”). Thus, to the primary router 320, it may appear that the packet has originated from the primary switch 220, and the MAC address of other components within the network device 34 will preferably be hidden from the egress network 300. In other words, a virtual “hop” has taken place between the media control interface 110d and the primary switch 220, since none of the internal MAC addressing between the components 110d, 220 is visible to the egress network 300. It should be understood that although the packet passed through the primary switch 220 in this exemplary embodiment, alternatively, it may also pass through the secondary switch 240 and enter either a primary router 320, 320a or a secondary router 320b.

In step 622, the packet with format 500 may be forwarded from the network device 34 to the primary router 320. From the primary router 320, the packet is preferably forwarded to the egress appliance 302 via the second network assembly 301. The operation of the second network assembly 301 is preferably complementary to that of the network assembly 30 and the packet may be converted back into circuit-switched data. Hence, the method of operation 600 shows how VoIP data sent from the ingress appliance 22 may be safely directed to the egress appliance 302 when the network system 10 is operating normally.

Turning now to FIG. 6b, an exemplary method of operation 650 of the network system 10 is shown. More specifically, FIG. 6b shows an exemplary method 650 when the network system is operable and data is sent from the egress network 300 to the ingress network 20. Hence, FIG. 6b preferably shows how data is transferred in the opposite direction from that specified in FIG. 6a. Accordingly, some of the steps in method 650 may be the reverse of the steps in method 600. In the first step 652, an egress sub-interface 224a on the primary switch 220 may receive a packet with format 500 from the primary router 320. It should be understood that alternatively, any egress sub-interface 224a-b, 224a′-b′, on any switch 220, 240 may receive the packet. Also, the packet may have been sent by the egress appliance 302 via the second network assembly 301 and converted from circuit-switched data.

In the present embodiment, the data fields within the packet with format 500 received by the egress sub-interface 224a in step 652 may correspond to the addresses shown in FIG. 5a. The source UDP address stored within the UDP header 506 may be the UDP address of the second media control interface 280a that has been mapped to the egress appliance 302 (“ABCD”). The destination UDP address stored within the UDP header 506 may be the UDP address of the media control interface 110d that has been mapped to the ingress appliance 22 (“AAAA”). Similarly, the source IP address within the IP header 508 of the packet 500 may be the IP address of the second media control interface 280a of the egress appliance 302 (“168.114.200.104”), and the destination IP address may be the IP address of the media control interface 110d of the ingress appliance 22 (“149.112.213.100”). Within the MAC header 510 of the packet 500, the source MAC address may be the MAC address of port 262 on the primary router 320 (“000003”), and the destination MAC address may be the MAC address of the egress sub-interface 224a of the primary switch 220 (“000002”). Alternatively, if the primary switch 220, first link 250, or active port 262 are inoperable, the source MAC address may be the MAC address of port 264 on the primary router 320 (“000005”) and the destination MAC address may be the MAC address of egress sub-interface 224a′ (“000004”). The destination MAC address may be determined by a second route server (not shown) within the second network assembly 301.

In step 654, the destination UDP address (“AAAA”) and destination IP address (“149.112.213.100”) may be inputted into the table 580 in order to output a MAC address (“000001”) from the MAC address field 586. The outputted MAC address may be the MAC address of one of the media control interfaces 110. In this exemplary embodiment, the outputted MAC address was found within entry 592 of the table 580 and it corresponds to the media control interface 110d. It should be understood that a variety of searching techniques may be utilized to find a desired MAC address, such as sequentially searching the table 580, utilizing pointers to skip within the table 580, or performing a sorting algorithm such as Quicksort before searching the table 580. Furthermore, in alternate embodiments, different values (e.g., RTP addresses, other types of addresses) may be inputted into the table 580 in order to output a desired value (e.g., destination MAC address).

In step 656, the destination MAC address within the MAC header 510 of the packet (“000002”) may be rewritten by the MAC address read from the table 580 (“000001”) that was obtained in the previous step 654. In this exemplary embodiment, by rewriting the destination MAC address within the MAC header 510, the packet may now be directed to the media control interface 110d. Thus, data may travel along the active connection 520 established between the egress appliance 302 and ingress appliance 22.

In step 658, a determination is made as to whether the destination MAC address of the packet with format 500 is known. If the destination MAC address is not known (e.g., due to an inaccurate destination MAC address in the table 580, a transmission error, etc.), the method may proceed to step 660 and the packet may be dropped. Alternatively, the packet may be copied and broadcast to the selection switch 140 via one or more of the ingress sub-interfaces 222, 222′. The packet may then be copied within the control switch 120 and further broadcast to all media control interfaces 110a-n.

Returning to the determination in step 658, if the destination MAC address of the packet is known, the method may proceed to step 662, where the packet may be forwarded to the ingress sub-interface 222c within the primary switch 220. The packet may be subsequently forwarded to the selection switch 140 within the control switch 120 via the first interface 150. Accordingly, in the following step 664, the selection switch 140 may direct the packet to the media control interface 110d by utilizing the destination MAC address within the MAC header (“000001”).

Turning now to step 668, the media control interface 110d may remove the packet headers, such as the RTP header 504, UDP header 506, IP header 508, and MAC header 510, from the packet with format 500. Additionally, the packet may be forwarded to the network interface 100. In step 670, the packet may be converted from packet-switched data to circuit-switched data. The circuit-switched data may then be forwarded to the ingress appliance 22. Hence, the method of operation 650 shows how VoIP data sent from the egress appliance 302 may be safely directed to the ingress appliance 22 when the network system 10 is operating normally.

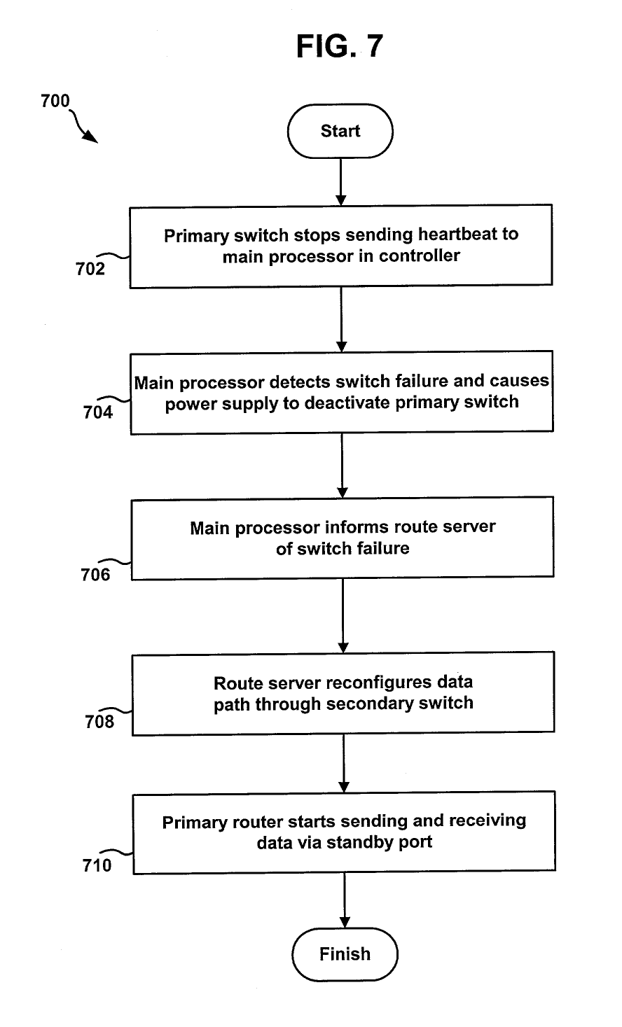

Turning now to FIG. 7, an exemplary method of operation 700 of the network system 10 is shown using the network device 34 and egress network 300 of FIG. 3. Additionally, FIG. 7 shows an exemplary method 700 when the primary switch 220 is inoperable. The method 700 begins with step 702, when the control processor 228 within the primary switch 220 stops sending the heartbeat signal to the main processor 424 in the controller 420. The heartbeat signal may be passively stopped due to the primary switch's inoperability, or because the primary switch 220 detects a failure and actively stops the heartbeat signal. In step 704, the main processor 424 detects the absence of the heartbeat from the primary switch 220. After a threshold period of time, such as fifty (50) milliseconds, the main processor 424 may determine that the primary switch 220 has failed, and may communicate with the power supply 422 in order to deactivate the primary switch 220. The power supply 422 may then deactivate the primary switch 220 and the first link 250 by shutting down the power (e.g., turning off the laser).

In step 706, the main processor 424 may inform the route server 440 about the failure of the primary switch 220. In step 708, the route server 440 may reconfigure the data path through the secondary switch 240. Thus, the standby connection 540 is preferably utilized when the primary switch 220 fails. In step 710, the primary router 320 may detect that the active port 262 associated with the primary switch 220 is not being used and that the standby port 264 associated with the secondary switch 240 is now active. Therefore, the primary router 320 will start sending and receiving data through the standby port 264. In the present embodiment, the data path may utilize the standby connection 540 in response to a failure within the primary switch 220.

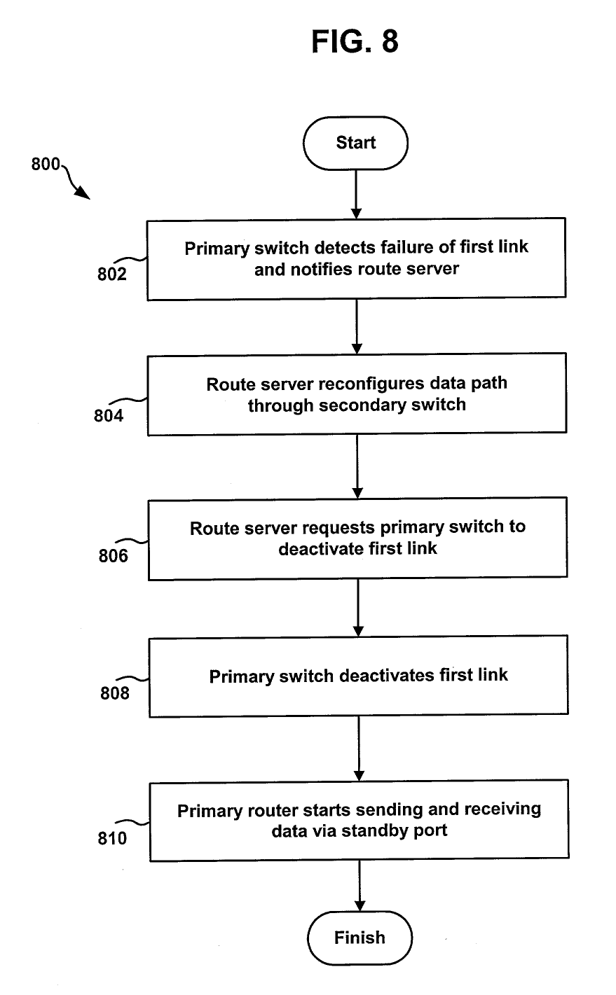

FIG. 8 shows an exemplary method of operation 800 of the network system 10 using the network device 34 and egress network 300 of FIG. 3. More specifically, FIG. 8 shows an exemplary method 800 when the first link 250 is inoperable. In the present embodiment, the primary switch 220 may monitor the power being supplied to the first link 250, the receipt of data from the egress network 300 along the first link 250, and other such parameters that indicate the health of the first link 250. Preferably, the primary switch 220 utilizes the control processor 228 and/or the network processors 230 for monitoring the first link 250. In step 802, the primary switch 220 may use its monitoring capability to detect a failure within the first link 250. Further, the primary switch 220 may use the control processor 228 to notify the route server 440 of the failure. It should be understood that alternatively, the controller 420 or another component within the network assembly 30 may also monitor the first link 250.

In step 804, the route server 440 may reconfigure the data path to travel through the secondary switch 240. In other words, the route server 440 may cause the selection switch 140 to forward data along the standby connection 540 instead of the active connection 520. In step 806, the route server 440 may send a request to the control processor 228 within the primary switch 220 to deactivate the first link 250 (e.g., shut down the laser). Although the power may be supplied by the power supply 422 in the controller 420, preferably, the primary switch 220 is also capable of shutting down the power to the first link 250. Thus, in step 808, the primary switch 220 may deactivate the first link 250 by shutting down its power. Also, the primary switch 220 may begin or continue to supply power to the second link 270. In step 810, the primary router 320 may detect that the active port 262 associated with the primary switch 220 is not being used and that the standby port 264 associated with the secondary switch 220 is now active. Therefore, the primary router 320 will start sending and receiving data through the standby port 264. In the present embodiment, the data path may be shifted from the active connection 520 to the standby connection 540 in response to a failure within the first link 250.

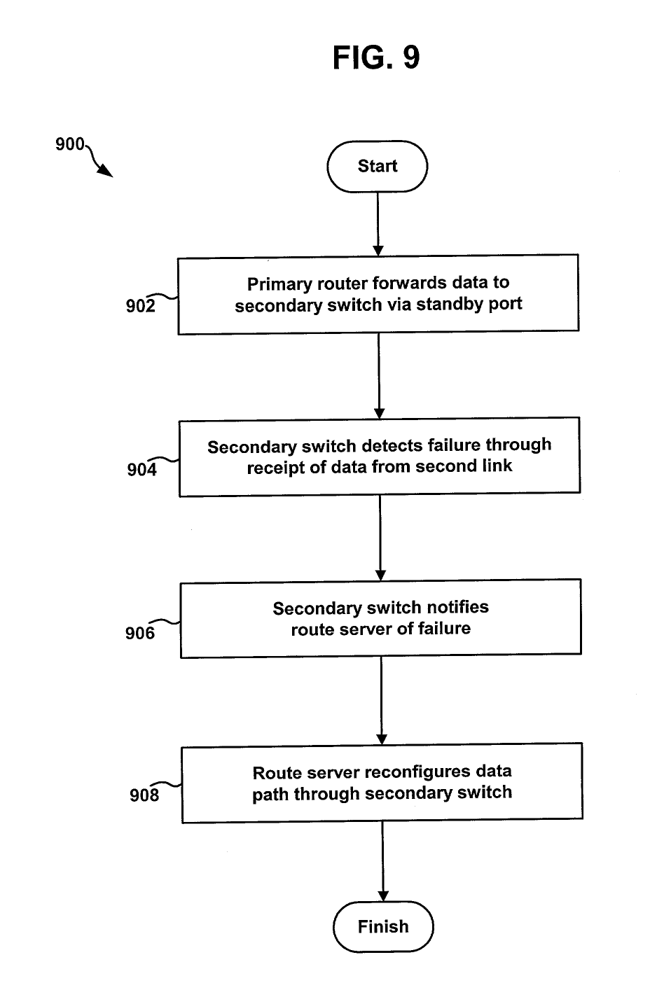

Turning now to FIG. 9, an exemplary method of operation 900 of the network system 10 is shown using the network device 34 and egress network 300 of FIG. 3. Further, the method 900 shows when the active port 262 of the primary router 320 is inoperable. In step 902, the primary router 320 begins forwarding packet-switched data to the secondary switch 240 via the standby port 264 and second link 270. In step 904, the secondary switch 240 may receive the data from the second link 270 through the egress sub-interface 224a′. After the secondary switch 240 receives data from the second link 270 beyond a certain threshold, such as three (3) UDP packets in one-hundred (100) milliseconds, the secondary switch 240 may detect that the active port 262 on the primary router 320 is inoperable.

In step 906, the control processor 228′within the secondary switch 240 may notify the route server 440 that the active port 262 is inoperable and that data is being forwarded via the standby port 264 and standby link 250. Alternatively, the primary switch 220 may notify the route server 440 that the active port 262 is no longer forwarding data and is inoperable. In step 908, the route server 440 may reconfigure the data path through the secondary switch 220. Thus, the standby connection 540 is preferably utilized when the active port 262 within the primary router 320 fails.

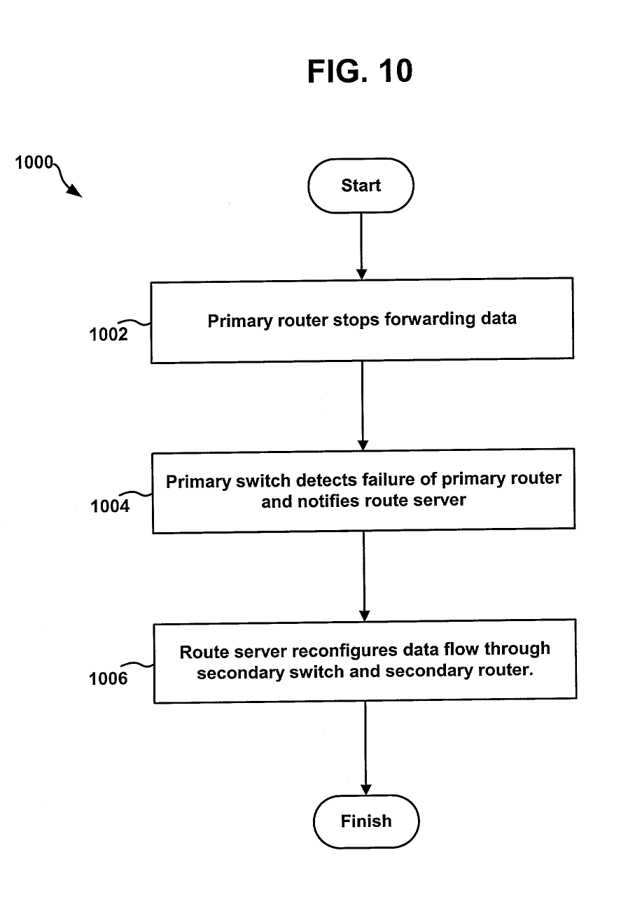

Turning now to FIG. 10, an exemplary method of operation 1000 of the network system 10 is shown with the network device 34 and egress network 300 of FIG. 4. In this exemplary method 1000, the primary router 320a may not be operable. Thus, in step 1002, the primary router 320a may stop forwarding data to the primary switch 220 in the network device 34. The method 1000 may then move to step 1004, where the primary switch 220 may detect that it is no longer receiving data from the primary router 320a. The primary switch 220 may then notify the route server 440 of the failure of the primary router 320a. In step 1006, the route server may reconfigure the data flow through the secondary switch 240, and a standby route passing from the secondary switch 240 to the secondary router 320b may then be utilized.

It should be understood that a wide variety of changes and modifications may be made to the embodiments of the network system described above. For example, a network system 10 with only one router (e.g., as shown in FIG. 3), may have more than one connection to the primary switch 220 and secondary switch 240, and these additional connections may be utilized as standbys if an active connection fails. Additionally, the normal functions and/or determinations handled by the various processors within the network system may be distributed to other intelligent components of the network system. Furthermore, certain components, functions, and operations of the network system of the present invention may be accomplished with hardware, software, and/or a combination of the two. In addition, more than two switches 220, 240 may be utilized in alternate embodiments of the present invention, and any number of routers may be present between the switches 220, 240 and the second network assembly 301. It is therefore intended that the foregoing description illustrates rather than limits this invention, and that it is the following claims, including all equivalents, that define this invention:

What is claimed is:

1. A network system comprising:
a network interface connected to a first network;
a primary switch connected to the network interface;
a secondary switch connected to the network interface; and
a second network connected to both the primary switch and the secondary switch;
wherein packet-switched data is transferred between the network interface and the second network across the primary switch if the primary switch is operable, and the packet-switched data is transferred between the network interface and the second network across the secondary switch if the primary switch is inoperable.

2. The network system of claim 1 further comprising a selection switch connected to the network interface, the primary switch, and the secondary switch, wherein the selection switch enables the packet-switched data to be transferred across the primary switch and the secondary switch.

3. The network system of claim 2 further comprising a route server connected to the selection switch, wherein the route server controls the functioning of the selection switch.

4. The network system of claim 1 further comprising a controller connected to the primary switch that determines if the primary switch is operable via a heartbeat mechanism.

5. The network system of claim 4, wherein the controller deactivates the primary switch if the primary switch is inoperable.

6. The network system of claim 1 further comprising a first link connecting the primary switch to the second network.

7. The network system of claim 6 wherein the packet-switched data is transferred across the primary switch if the first link is operable, and the packet-switched data is transferred across the secondary switch if the first link is inoperable.

8. The network system of claim 6, wherein the first link comprises optical fiber.

9. The network system of claim 8, wherein a laser utilized for transmitting the packet-switched data along the first link is deactivated if at least one of the primary switch and first link are inoperable.

10. The network system of claim 8, wherein a laser utilized for transmitting the packet-switched data along the first link is explicitly deactivated if maintenance operations are to be performed on at least one of the primary switch and first link.

11. The network system of claim 1, wherein the network interface comprises a digital signal processing card for converting between circuit-switched data and the packet-switched data.

12. The network system of claim 1, wherein the packet-switched data comprises Internet protocol packets.

13. The network system of claim 1, wherein the second network comprises a primary router.

14. The network system of claim 13, wherein the second network further comprises a secondary router, the packet-switched data is transferred between the network interface and the primary router if the primary router is operable, and the packet-switched data is transferred between the network interface and the secondary router if the primary router is inoperable.

15. A method for transferring packet-switched data comprising:
determining if a primary switch and a first link are operable;
transferring packet-switched data across the primary switch if the primary switch and the first link are operable; and
transferring packet-switched data across a secondary switch if at least one of the primary switch and the first link are inoperable.

16. The method of claim 15 further comprising deactivating the primary switch and activating the secondary switch if at least one of the primary switch and the first link are inoperable.

17. The method of claim 16, wherein the step of deactivating the primary switch comprises terminating fiber optic communications between the primary switch and a network.

18. The method of claim 15 further comprising determining if a primary router is operable.

19. The method of claim 18 further comprising transferring the packet-switched data between a network interface and the primary router if the primary router is operable.

20. The method of claim 18 further comprising transferring the packet-switched data between a network interface and a secondary router if the primary router is inoperable.

21. The method of claim 15 further comprising converting between circuit-switched data and the packet-switched data.

22. The method of claim 15, wherein the packet-switched data comprises Internet protocol packets.

23. The method of claim 15, wherein the step of determining if the primary switch and the first link are operable further comprises monitoring the primary switch via a heartbeat mechanism.

24. A network assembly comprising:
a digital signal processing card for converting between circuit-switched data and Internet protocol packets;
a primary switch connected to the digital signal processing card;
a secondary switch connected to the digital signal processing card;
a selection switch connected to the digital signal processing card, the primary switch and the secondary switch, wherein the selection switch enables the Internet protocol packets to be transferred across the primary switch if the primary switch is operable, and across the secondary switch if the primary switch is inoperable;
a route server connected to the selection switch, wherein the route server controls the functioning of the selection switch; and
a controller connected to the primary switch, wherein the controller monitors the primary switch and deactivates the primary switch if the primary switch is inoperable.

25. The network device of claim 24, wherein an Internet protocol network is connected to both the primary switch and the secondary switch, and the Internet protocol network includes a primary router and a secondary router.

26. The network device of claim 25, wherein the Internet protocol packets are transferred between the digital signal processing card and the primary router if the primary router is operable, and the Internet protocol packets are transferred between the digital signal processing card and the secondary router if the primary router is inoperable.

27. The network device of claim 24, wherein the controller monitors the primary switch via a heartbeat mechanism.
